(19) United States
(12) Patent Application Publication
(10) Pub. No.: US 2026/0120950 A1
(43) Pub. Date: Apr. 30, 2026

(54) MULTILAYER ELECTRONIC COMPONENT

(71) Applicant: SAMSUNG ELECTRO-MECHANICS CO., LTD., Suwon-si (KR)

(72) Inventors: Do Hoon KIM, Suwon-si (KR); Jae Hoon JI, Suwon-si (KR); Eun Young LEE, Suwon-si (KR); Seung Hun KANG, Suwon-si (KR); Won Hee CHA, Suwon-si (KR); Kyung Ryul LEE, Suwon-si (KR); Hong Seok KIM, Suwon-si (KR); Bum Soo KIM, Suwon-si (KR)

(73) Assignee: SAMSUNG ELECTRO-MECHANICS CO., LTD., Suwon-si (KR)

(21) Appl. No.: 19/331,788

(22) Filed: Sep. 17, 2025

(30) Foreign Application Priority Data
Oct. 24, 2024 (KR) 10-2024-0146521
Apr. 8, 2025 (KR) 10-2025-0045431

(51) Int. Cl. H01G 4/12; H01G 4/005; H01G 4/232; H01G 4/248; H01G 4/30

(52) U.S. Cl. CPC H01G 4/1227; H01G 4/005; H01G 4/232; H01G 4/248; H01G 4/30

(57) ABSTRACT

A multilayer electronic component includes a body including a first dielectric layer, a second dielectric layer and internal electrodes; and external electrodes disposed on the body, wherein the first dielectric layer includes a BaTiO₃ material as a main component, and wherein the second dielectric layer includes (α_{β}Γ_{δ})TiₓO_{y} (β≥0, δ≥0, x>0, y>0) material, different from the main component of the first dielectric layer, as a main component, α is one or more of Ba, Er, Ca or Sr, and Γ is one or more of Nb, Mg, Ta, In, Mn, Hf, Zr or Al.

### CROSS-REFERENCE TO RELATED APPLICATION(S)

This application claims benefit of priority to Korean Patent Application No. 10-2025-0045431 filed on Apr. 8, 2025 in the Korean Intellectual Property Office and Korean Patent Application No. 10-2024-0146521 filed on Oct. 24, 2024 in the Korean Intellectual Property Office, the disclosures of which are incorporated herein by reference in their entirety.

### BACKGROUND

### 1. Field

The present disclosure relates to a multilayer electronic component.

### 2. Description of Related Art

A multilayer ceramic capacitor (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, charging or discharging electricity therein or therefrom.

Such a multilayer ceramic capacitor may be used as a component of various electronic devices, since a multilayer ceramic capacitor may have a small size and high capacitance and may be easily mounted. As various electronic devices such as a computer and a mobile device have been designed to have a smaller size and higher output, demand for miniaturization and increased capacitance of a multilayer ceramic capacitor has increased.

A high-capacity multilayer ceramic capacitor may be manufactured by reducing a thickness of a dielectric layer, but as a thickness of a dielectric layer reduces, it may be highly likely that overall insulation properties of the multilayer ceramic capacitor may deteriorate. To this end, various studies have been conducted to improve a structure and material, for example, to strengthen dielectric/insulating properties of a material.

However, when the dielectric layer is excessively thinned or additives are improperly added to barium titanate (BaTiO₃), which may be used as a general dielectric material for a multilayer ceramic capacitor, side effects such as reduced process workability, frequent process defects, and reduced dielectric/insulating properties may be accompanied.

For example, when a thinned dielectric layer is used, the dielectric layer may be vulnerable to even minor factors, which may increase a process defect rate. For example, various defects such as sheet folding due to static electricity, dielectric/internal electrode layer disconnection, defective illumination, cracks, and delamination may occur. The defects may eventually become the preferred sites for burnt-out, or the like, when high electric fields are applied, and the defects become factors which deteriorate characteristics and quality of a multilayer ceramic capacitor or reduces a function as a capacitor.

### SUMMARY

An embodiment of the present disclosure is to provide, by applying dielectric layers of different dielectric materials, a multilayer electronic component having excellent withstand voltage characteristics and reliability by preventing burn-out, cracks, or shorts under a high-voltage environment.

According to an embodiment of the present disclosure, a multilayer electronic component may include: a body including a first dielectric layer, a second dielectric layer and internal electrodes; and external electrodes disposed on the body, wherein the first dielectric layer may include a BaTiO₃ material as a main component, and wherein the second dielectric layer may include (α_{β}Γ_{δ})TiₓO_{y} (β≥0, δ≥0, x>0, y>0) material, different from the main component of the first dielectric layer, as a main component, a is one or more selected from the group consisting of Ba, Er, Ca and Sr, and Γ is one or more selected from the group consisting of Nb, Mg, Ta, In, Mn, Hf, Zr and Al.

### BRIEF DESCRIPTION OF DRAWINGS

The and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is a cross-sectional diagram taken along line I-I′ in FIG. 1;

FIGS. 3A, 3B, and 3C are cross-sectional diagrams taken along line II-II′ in FIG. 1 according to various embodiments of the present disclosure;

FIG. 4 is a cross-sectional diagram taken along line II-II′ in FIG. 1;

FIG. 5 is a cross-sectional diagram taken along line II-II′ in FIG. 1 according to various embodiments of the present disclosure;

FIG. 6 is a graph of step IR evaluation of comparative examples and embodiments; and

FIGS. 7A, 7B, 7C, and 7D are images of burnt-out occurring in comparative examples taken by an optical microscope (OM) and a scanning electron microscope (SEM).

### DETAILED DESCRIPTION

Hereinafter, some embodiments of the present disclosure will be described as below with reference to the accompanying drawings.

The present disclosure may be modified in many different manners and should not be construed as being limited to the embodiments set forth herein. Also, the embodiments of the present disclosure are provided to describe the present disclosure to those skilled in the art. Accordingly, the shapes and sizes of elements in the drawings may be exaggerated for clearer description, and elements indicated by the same reference numerals in the drawings may be the same elements.

To describe the present disclosure in the drawings, portions not related to the description are omitted, and the size and dimension of each component illustrated in the drawings are arbitrarily represented for the ease of description, and thus, the present disclosure is not necessarily limited to the drawings. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the Z-direction may be defined as the thickness direction or the first direction, the X-direction may be defined as the length direction or the second direction, and the Y-direction may be defined as the width direction or the third direction. The lamination direction may be the thickness direction or the width direction.

### Multilayer Electronic Component

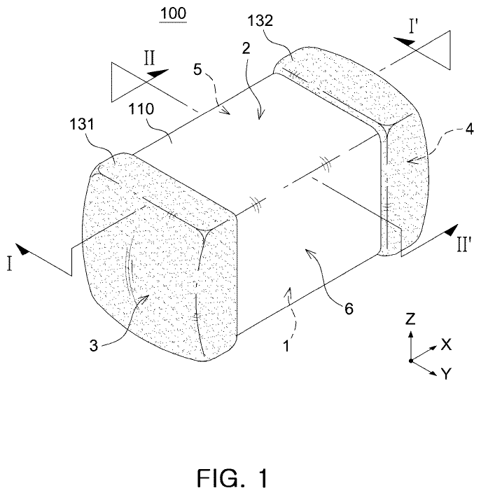

FIG. 1 is a perspective diagram illustrating a multilayer electronic component according to an embodiment.

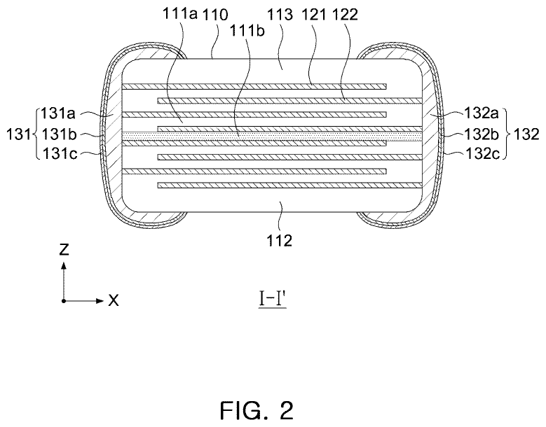

FIG. 2 is a cross-sectional diagram taken along line I-I′ in FIG. 1.

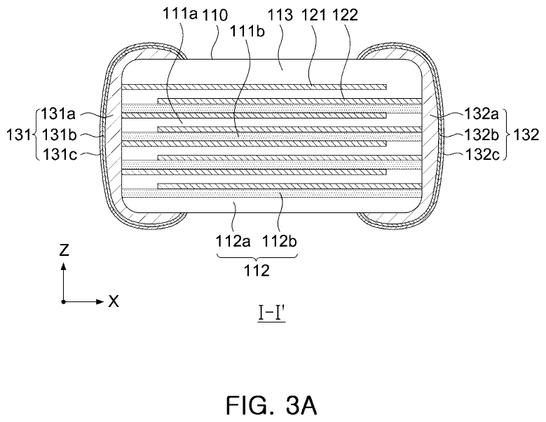

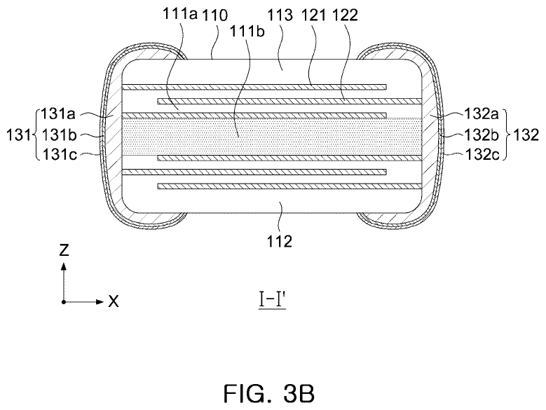

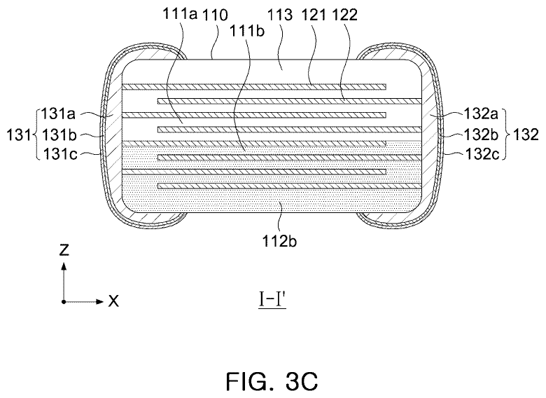

FIGS. 3A, 3B, and 3C are cross-sectional diagrams taken along line II-II′ in FIG. 1 according to various embodiments.

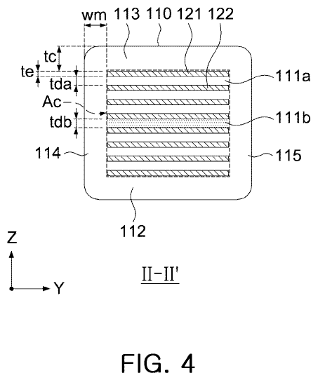

FIG. 4 is a cross-sectional diagram taken along line II-II′ in FIG. 1.

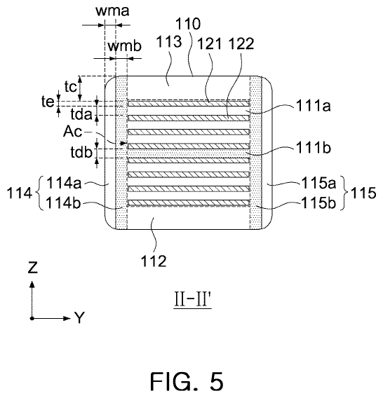

FIG. 5 is a cross-sectional diagram taken along line II-II′ in FIG. 1 according to various embodiments.

Hereinafter, a multilayer electronic component according to an embodiment will be described in greater detail with reference to FIGS. 1 to 5. A multilayer ceramic capacitor will be described as an example of a multilayer electronic component, but an embodiment thereof is not limited thereto, and the multilayer ceramic capacitor may be applied to various multilayer electronic components, such as an inductor, a piezoelectric element, a varistor, or a thermistor.

A multilayer electronic component 100 according to an embodiment may include: a body 110 including a first dielectric layer 111a, a second dielectric layer 111b and internal electrodes 121 and 122; and external electrodes 131 and 132 disposed on the body 110, the first dielectric layer 111a may include a BaTiO₃ material as a main component, and the second dielectric layer 111b may include (α_{β}Γ_{δ}) TiₓO_{y} (β≥0, δ≥0, x>0, y>0) material, different from the main component of the first dielectric layer 111a, as a main component, and a is one or more selected from the group consisting of Ba, Er, Ca and Sr, and Γ is one or more selected from the group consisting of Nb, Mg, Ta, In, Mn, Hf, Zr and Al.

In the body 110, the dielectric layers 111 and the internal electrodes 121 and 122 may be alternately laminated. The dielectric layer 111 may include the first dielectric layer 111a and the second dielectric layer lib, and the description of the dielectric layer 111 below may correspond to the description of the first dielectric layer 111a and the second dielectric layer 111b unless otherwise indicated.

More specifically, the body 110 may include a capacitance forming portion Ac disposed in the body 110 and forming capacitance by including a first internal electrode 121 and a second internal electrode 122, alternately disposed to oppose each other with the dielectric layer 111a and the dielectric layer 111 interposed therebetween. That is, the capacitance formation portion Ac may include the first dielectric layer 111a, the second dielectric layer 111b, and the first internal electrode 121 and the second internal electrode 122 alternately disposed with at least one of the first dielectric layer 111a and the second dielectric layer 111b interposed therebetween.

The shape of the body 110 may not be limited to any particular shape, but as illustrated, the body 110 may have a hexahedral shape or a shape similar to a hexahedral shape. Due to reduction of ceramic powder included in the body 110 during a firing process, the body 110 may not have an exactly hexahedral shape formed by linear lines but may have a substantially hexahedral shape.

The body 110 may have the first and second surfaces 1 and 2 opposing each other in the first direction, the third and fourth surfaces 3 and 4 connected to the first and second surfaces 1 and 2 and opposing in the second direction, and the fifth and sixth surfaces 5 and 6 connected to the first to fourth surfaces 1, 2, 3, and 4 and opposing each other in the third direction.

The plurality of dielectric layers 111 forming the body 110 may be in a fired state, and boundaries between the adjacent dielectric layers 111 may be integrated with each other such that the boundaries may not be distinct without using a scanning electron microscope (SEM).

The raw material for forming the dielectric layer 111 is not limited as long as sufficient capacitance may be obtained therewith. The dielectric layer 111 may include a first dielectric layer 111a including a barium titanate (BaTiO₃) material as a main component, and a second dielectric layer 111b including a (α_{β}Γ_{δ})TiₓO_{y} (β≥0, δ≥0, x>0, y>0) material as a main component to prevent burn-out, cracks, or shorts under a high-voltage environment. Here, α may be positioned at the A-site element site of the perovskite (ABO₃) material, and Γ may be positioned at the B-site element site, but an embodiment thereof is not limited thereto. In this case, the main component of the second dielectric layer 111b and the main component of the first dielectric layer 111a may be different, α may be one or more selected from the group consisting of Ba, Er, Ca and Sr, and Γ may be one or more selected from the group consisting of Nb, Mg, Ta, In, Mn, Hf, Zr and Al. Here, the notion that the main component of the second dielectric layer 111b is different from the main component of the first dielectric layer 111a may indicate that, when the main component of the first dielectric layer 111a is BaTiO₃, the main component of the second dielectric layer 111b may be a (α_{β}Γ_{δ}) TiₓO_{y} (β≥0, δ≥0, x>0, y>0) material other than BaTiO₃. More specifically, for example, when the main component of the first dielectric layer 111a is BaTiO₃, the main component of the second dielectric layer 111b may be Ba(Nb_{0.02}Al_{0.02}) Ti_{0.96}O₃.

In the embodiments, the term “main component” may indicate a component occupying a relatively large weight ratio or an atomic number ratio as compared to other components, and may indicate a component exceeding 50 wt % based on a weight of the entire composition included in a specific configuration (e.g., the first dielectric layer and the second dielectric layer), a component exceeding 50 at % based on the number of atoms, or a component exceeding 50 mol % based on the number of moles.

As an example of a specific method of measuring the contents of elements included in each component of the multilayer electronic component 100, the component may be analyzed using the energy dispersive X-ray spectroscopy (EDS) mode of a scanning electron microscope (SEM), the EDS mode of a transmission electron microscope (TEM), or the EDS mode of a scanning transmission electron microscope (STEM). First, a thinned analysis sample may be prepared using a focused ion beam (FIB) device in the region to be measured. The damage layer on the surface of the thinned sample may be removed using xenon (Xe) or argon (Ar) ion milling, each component to be measured may be mapped from the image obtained using SEM-EDS, TEM-EDS, or STEM-EDS, and qualitative/quantitative analysis may be performed. In this case, the qualitative/quantitative analysis graph of each component may represent the content of each element in, for example, mass percentage (wt %), atomic percentage (at %), or mole percentage (mol %), and may also represent the content of another specific component with respect to the content of a specific component.

As the first dielectric layer 111a, a barium titanate (BaTiO₃) material may be used. Barium titanate (BaTiO₃) material may include BaTiO₃ ceramic particles, and an example of ceramic particles may include (Ba₁₋ₓCaₓ) TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) or Ba(Ti_{1-y}Zr_{y})O₃ (0<y<1) in which Ca (calcium) and Zr (zirconium) are partially dissolved.

Also, as a raw material for forming the dielectric layer 111a, various ceramic additives, organic solvents, binders, and dispersants may be added to particles such as barium titanate (BaTiO₃) in embodiments.

The second dielectric layer 111b may include (α_{β}Γ_{δ})TiₓO_{y} (β≥0, δ≥0, x>0, y>0) material as a main component, and α may be one or more selected from the group consisting of Ba, Er, Ca and Sr, and Γ may be one or more selected from the group consisting of Nb, Mg, Ta, In, Mn, Hf, Zr and Al. As an example of the (α_{β}Γ_{δ})TiₓO_{y} (β≥0, δ≥0, x>0, y>0) material, at least one selected from the group consisting of Ba(Nb, Ti)O₃, Ba(Nb, Al, Ti)O₃, Ba(Nb, Ti, Al, Mn)O₃, Ba(Nb, Hf, Ti)O₃, (Ba, Sr) (Nb, Ti)O₃ and (Sr, Er) TiO₃ may be included, and more specifically, Ba(Nb_{0.02}Mg_{0.02}) Ti_{0.96}O₃, Ba(Nb_{0.02}Al_{0.02}) Ti_{0.96}O₃, (Er)_{0.012}Sr_{0.98}TiO₃, (Ta_{0.01}In_{0.01}) Ti_{0.98}O₂, or Sr(Nb_{0.05}Al_{0.05}) Ti_{0.90}O₃ may be included. However, an embodiment thereof is not limited thereto, and any dielectric material may be used as long as the total content of a dopant doped in the (α_{β}Γ_{δ}) TiₓO_{y} (β≥0, δ≥0, x>0, y>0) material satisfies 10 mol % or less based on the element site in which the dopant is doped. However, the material may be different from the main component of the first dielectric layer 111a, preferably. The dopant may include at least one selected from the group consisting of Nb, Mg, Ta, In, Mn, Hf, Zr and Al.

Here, the configuration in which the total content of the dopant doped in the (α_{β}Γ_{δ}) TiₓO_{y} (β≥0, δ≥0, x>0, y>0) material is 10 mol % or less based on the element site in which the dopant is doped (i.e., either the A-site or the B-site where the dopant is introduced) may indicate that, when the total content of atoms which may be positioned at the A-site, B-site of perovskite (ABO₃) or titanium dioxide (TiO₂) or the Ti-site of titanium dioxide is 100 mol, the total content of the doped dopant may be 10 mol or less. To describe more specifically with an example, in Ba(Nb_{0.02}Al_{0.02}) Ti_{0.96}O₃, Nb and Al may be dopants doped to the Ti-site corresponding to the B-site of the perovskite (ABO₃) material, and the element site doped with the dopant indicates the Ti-site corresponding to the B-site. The notion that the total content of the dopant is 10 mol % may indicate that, when the total content of Nb, Al and Ti, which may be the element site Ti-site doped with the dopant, is 100 mol, the total content of the dopant Nb and Al may be 10 mol or less. That is, based on 100 mol (Nb 2 mol+Al 2 mol+Ti 96 mol) in the element site (B-site) doped with a dopant of Ba(Nb_{0.02}Al_{0.02}) Ti_{0.96}O₃, the total dopant content may be 4 mol (Nb 2 mol+Al 2 mol).

Also, as for the raw material for forming the second dielectric layer 111b, various ceramic additives, organic solvents, binders, dispersants, or the like, may be added to (α_{β}Γ_{δ}) TiₓO_{y} (β≥0, δ≥0, x>0, y>0) material particles in embodiments.

In the embodiments, by including the second dielectric layer 111b, burnt-out may not occur under a high voltage/high electric field environment, and when no voltage/electric field is applied, dielectric properties or insulation properties may be recovered, and other properties may not be deteriorated. Also, a higher permittivity than that of the first dielectric layer 111a may be obtained, which may contribute to increasing nominal capacitance or effective capacitance.

The number of laminated layers of the second dielectric layer 111b is not limited to any particular example, and may preferably be the same as or less than the number of laminated layers of the first dielectric layer 111a. That is, the number of laminated layers of the first dielectric layer 111a may be greater than the number of laminated layers of the second dielectric layer 111b, preferably.

This is because the second dielectric layer 111b may have a higher dissipation factor (DF) and somewhat lower resistivity properties or insulation resistance (IR) properties than those of the first dielectric layer 111a, which may entail unintended property resistance. Thus, the number of laminated layers of the first dielectric layer 111a may be designed to be greater than the number of laminated layers of the second dielectric layer 111b, preferably.

The first dielectric layer 111a and the second dielectric layer 111b may be formed using a dielectric material, and may thus include a dielectric microstructure after firing. The dielectric microstructure may include a plurality of grains, grain boundaries disposed between adjacent grains, and triple points disposed at points at which three or more grain boundaries are in contact with each other, and may include a plurality of grains, a plurality of grain boundaries, and a plurality of triple points.

The average thicknesses tda and tdb of the dielectric layers 111a and 111b, that is, the average thickness tda of the first dielectric layer 111a and the average thickness tdb of the second dielectric layer 111b, may not need to be specifically limited.

However, to easily obtain miniaturization and high capacitance of the multilayer electronic component and to improve withstand voltage properties, the average thickness tda of the first dielectric layer 111a may be 1.0 μm or less, 0.9 μm or less, 0.8 μm or less, 0.7 μm or less, 0.6 μm or less, or 0.5 μm or less, and the average thickness tdb of the second dielectric layer 111b may be 1.5 μm or less, 1.4 μm or less, 1.3 μm or less, 1.2 μm or less, 1.1 μm or less. That is, the average thickness tda of the first dielectric layer 111a may satisfy tda≤1.0 μm, and the average thickness tdb of the second dielectric layer 111b may satisfy tdb≤1.5 μm.

Here, the average thicknesses tda and tdb of the dielectric layers 111a and 111b may indicate the average thicknesses tda and tdb of the dielectric layers 111a and 111b disposed between the first and second internal electrodes 121 and 122.

The average thickness tda and tdb of the dielectric layers 111a and 111b may indicate the average thickness tda and tdb of one dielectric layer 111a and 111b, or may indicate the average thickness tda and tdb of each of a plurality of dielectric layers 111a and 111b, or may indicate the average thickness tda and tdb of a plurality of dielectric layers 111a and 111b.

The average thickness tda and tdb of the dielectric layers 111a and 111b may be measured by scanning a cross-section in the length and thickness directions of the body 110 using a scanning electron microscope (SEM) at 10,000 times magnification. More specifically, the average thickness tda and tdb of one dielectric layer 111a and 111b may indicate an average value calculated by measuring the thickness of one dielectric layer at five points at an equal distance in the length direction in the scanned image. The five points at an equal distance may be specified in the capacitance formation portion Ac. Also, by extending the average value measurement to five the same dielectric layers and measuring the average value, the average thickness of the plurality of dielectric layers may be further generalized.

The average thickness tdb of the second dielectric layer 111b may be 1 time or greater and 2 times or greater than the average thickness tda of the first dielectric layer 111a, preferably. That is, 1≤tdb/tda≤2 may be satisfied.

As the average thickness tdb of the second dielectric layer 111b satisfies a value 1 time or greater and 2 times or greater than the average thickness tda of the first dielectric layer 111a, miniaturization and high capacitance of the multilayer electronic component may be obtained, and withstand voltage properties may improve.

When the average thickness tdb of the second dielectric layer 111b is more than 2 times the average thickness tda of the first dielectric layer 111a, the thickness of the average thickness of the dielectric layer may increase such that dielectric capacitance may be reduced. When the average thickness tdb of the second dielectric layer 111b is less than 1 time the average thickness tda of the first dielectric layer 111a, it may be difficult to effectively prevent burnt-out under a high-voltage environment.

The internal electrodes 121 and 122 may be alternately laminated with the dielectric layers 111a and 111b, and more specifically, the internal electrodes 121 and 122 may be alternately laminated with at least one of the first dielectric layer 111a and the second dielectric layer 111b.

The internal electrodes 121 and 122 may include the first internal electrode 121 and the second internal electrode 122, and the first and second internal electrodes 121 and 122 may be alternately disposed to oppose each other with the dielectric layers 111a and 111b included in the body 110 interposed therebetween, and may be exposed to the third and fourth surfaces 3 and 4 of the body 110, respectively.

More specifically, the first internal electrode 121 may be spaced apart from the fourth surface 4 and may be exposed through the third surface 3, and the second internal electrode 122 may be spaced apart from the third surface 3 and may be exposed through the fourth surface 4. The first external electrode 131 may be disposed on the third surface 3 of the body 110 and may be connected to the first internal electrode 121, and the second external electrode 132 may be disposed on the fourth surface 4 of the body 110 and may be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. In this case, the first and second internal electrodes 121 and 122 may be electrically separated from each other by the dielectric layer 111 disposed therebetween.

The body 110 may be formed by alternately laminating ceramic green sheets on which the first internal electrodes 121 are printed and ceramic green sheets on which the second internal electrodes 122 are printed, and firing the sheets. As the printing method of the conductive paste for internal electrode, a screen printing method or a gravure printing method may be used, but an embodiment thereof is not limited thereto.

The lamination order of the first dielectric layer 111a, the second dielectric layer 111b and the internal electrodes 121 and 122 may not be limited to any particular example.

For example, only one layer of the second dielectric layer 111b may be disposed as in FIG. 2, or first dielectric layer 111a-first internal electrode 121-second dielectric layer 111b-second internal electrode 122 may be repeatedly laminated as in FIG. 3A, only the second dielectric layer 111b having a thickness greater than the average thickness tda of the first dielectric layer 111a may be disposed as in FIG. 3B, or the first and second internal electrodes 121 and 122 may be alternately disposed with the second dielectric layer 111b interposed therebetween, and the first and second internal electrodes 121 and 122 may be alternately disposed with the first dielectric layer 111a interposed therebetween as in FIG. 3C. Although not illustrated in the drawing, the form may be first internal electrode 121-first dielectric layer 111a-second dielectric layer 111b-second internal electrode 122 or first internal electrode 121-second dielectric layer 111b-first dielectric layer 111a-second internal electrode 122.

The material for forming the first and second internal electrodes 121 and 122 is not limited to any particular example, and a material having excellent electrical conductivity may be used. For example, the first and second internal electrodes 121 and 122 may include one or more selected from the group consisting of nickel (Ni), copper (Cu), palladium (Pd), silver (Ag), gold (Au), platinum (Pt), tin (Sn), tungsten (W), titanium (Ti), and alloys thereof.

The thickness te of the internal electrodes 121 and 122 may not be specifically limited, and the description of the thickness te of the internal electrodes 121 and 122 below may indicate the thickness te of each of the first internal electrode 121 and the second internal electrode 122.

To obtain miniaturization and high capacitance of the multilayer electronic component 100, the thickness te of the internal electrodes 121 and 122 may be 1.0 μm or less, 0.8 μm or less, or 0.6 μm or less, and to obtain ultra-miniaturization, the thickness may be 0.5 μm or less, or 0.4 μm or less.

In this case, the thickness te of internal electrodes 121 and 122 may include the thickness te of at least one of the plurality of internal electrodes 121 and 122, or may include the thickness te of both the internal electrodes 121 and 122.

In this case, the thickness te of internal electrodes 121 and 122 may include the thickness te of at least one of the plurality of internal electrodes 121 and 122, or may include the thickness te of each of the internal electrodes 121 and 122.

Also, the thickness te of the internal electrodes 121 and 122 may indicate the average thickness te of one of the internal electrodes 121 and 122, may indicate the average thickness te of each of the plurality of internal electrodes 121 and 122, or may indicate an average thickness te of the plurality of internal electrodes 121 and 122.

The average thickness te of the internal electrodes 121 and 122 may be measured by scanning a cross-section in the length and thickness directions of the body 110 using a scanning electron microscope (SEM) with a magnification of 10,000×. More specifically, the average thickness te of one of the internal electrodes 121 and 122 may be an average value obtained by measuring thicknesses of 5 points at an equal distance in the length direction of the internal electrode in the scanned image. The 5 points at an equal distance may be designated in the capacitance formation portion Ac. Also, by extending the measurement of the average value to 3 internal electrodes 121 and 122, the average size of the internal electrodes 121 and 122 may be further generalized.

The body 110 may include cover portions 112 and 113 disposed in the capacitance forming portion Ac in the thickness direction.

More specifically, the body 110 may include a first cover portion 112 disposed on one surface in the thickness direction of the capacitance formation portion Ac and a second cover portion 113 disposed on the other surface in the thickness direction of the capacitance formation portion Ac. More specifically, the body 110 may include the first cover portion 112 disposed in the lower portion in the thickness direction of the capacitance formation portion Ac and the second cover portion 113 disposed in the upper portion in the thickness direction of the capacitance formation portion Ac.

The first cover portion 112 and the second cover portion 113 may be formed by disposing or laminating a single third dielectric layer or two or more third dielectric layers on the upper and lower surfaces of the capacitance formation portion Ac in the thickness direction, respectively, and may basically prevent damage to the internal electrodes 121 and 122 due to physical or chemical stress.

The first cover portion 112 and the second cover portion 113 may not include the internal electrodes 121 and 122, and may include the same dielectric material as that of the first dielectric layer 111 of the capacitance formation portion Ac. That is, the third dielectric layer included in the first cover portion 112 and the second cover portion 113 may include a dielectric material, for example, a barium titanate (BaTiO₃) dielectric material.

The thickness tc of the cover portions 112 and 113 may not be specifically limited, and in the description below, the description of the thickness tc of the cover portions 112 and 113 may be applied to the thickness tc of each of the first cover portion 112 and the second cover portion 113, and may be applied to the thickness tc including the entirety of the second dielectric layers 112b and 113b and the third dielectric layers 112a and 113a described below.

However, to easily obtain miniaturization and high capacitance of the multilayer electronic component 100, the thickness tc of the cover portions 112 and 113 may be 100 μm or less or 50 μm or less, preferably 30 μm or less, and more preferably 20 μm or less in an ultra-small product.

Here, the thickness tc of the cover portions 112 and 113 may indicate the average thickness of the cover portions 112 and 113.

Also, the average thickness tc of the cover portions 112 and 113 may indicate the average thickness tc of each of the first and second cover portions 112 and 113, or may indicate the average thickness tc of the first and second cover portions 112 and 113.

The average thickness tc of the cover portions 112 and 113 may be measured by scanning a cross-section in the length and thickness directions of the body 110 using a scanning electron microscope (SEM) at a magnification of 10,000. More specifically, the average thickness may indicate the average value calculated by measuring the thicknesses of at 5 points at an equal distance in the length direction in the scanned image of the cover portions 112 and 113.

Also, the average thickness tc of the cover portions 112 and 113 measured by the above-described method may have substantially the same value as the average thickness of the cover portions 112 and 113 in the cross-section in the width and thickness directions of the body 110.

The cover portions 112 and 113 may include a second dielectric layer, and more specifically, at least one of the first and second cover portions 112 and 113 may include a second dielectric layer.

In other words, at least a portion of the cover portions 112 and 113 may include a (α_{β}Γ_{δ}) TiₓO_{y} (β≥0, δ≥0, x>0, y>0) material different from the barium titanate (BaTiO₃)-based dielectric material as a main component.

Hereinafter, when the cover portions 112 and 113 include a second dielectric layer, for ease of description, the reference numerals thereof may be represented the same as the second dielectric layers 112b and 113b (not illustrated), which may be the same as the second dielectric layer 111b of the capacitance formation portion Ac, which may be easily understood by a person skilled in the art.

More specifically, the cover portions 112 and 113 may include at least one of second dielectric layers 112b or 113b and third dielectric layers 112a and 113a. In other words, the cover portions 112 and 113 may include the third dielectric layers 112a and 113a or the second dielectric layers 112b and 113b, or a portion of the cover portions 112 and 113 may include the second dielectric layers 112b and 113b and the other portion may include the third dielectric layers 112a and 113a.

In this case, the second dielectric layers 112b and 113b included in the cover portions 112 and 113 may be disposed to be in contact with the capacitance formation portion Ac, preferably.

The second dielectric layers 112b and 113b of the cover portions 112 and 113 may not contribute to forming capacitance, but as the second dielectric layers 112b and 113b are disposed to be in contact with the capacitance formation portion Ac, the second dielectric layers 112b and 113b may prevent burnt-out or insulation breakdown caused by unintended electric field concentration under a high-voltage environment.

When the cover portions 112 and 113 include both the second dielectric layers 112b and 113b and the third dielectric layers 112a and 113a, the second dielectric layers 112b and 113b may be disposed to be in contact with the capacitance formation portion Ac, and the third dielectric layers 112a and 113a may be disposed to be in contact with the second dielectric layers 112b and 113b. That is, the second dielectric layers 112b and 113b of the cover portions 112 and 113 may be disposed in the inner direction of the capacitance formation portion Ac based on the thickness direction, and the third dielectric layers 112a and 113a may be disposed in the outer direction of the capacitance formation portion Ac based on the thickness direction.

The multilayer electronic component 100 may include side margin portions 114 and 115, which may be end regions in the width direction of the internal electrodes 121 and 122.

More specifically, the side margin portions 114 and 115 may include a first side margin portion 114 disposed between the internal electrodes 121 and 122 and the fifth surface 5, and a second side margin portion 115 disposed between the internal electrodes 121 and 122 and the sixth surface 6.

As illustrated in FIG. 4, the side margin portions 114 and 115 may be a region between both ends in the width direction of the first and second internal electrodes 121 and 122 and the boundary surface of the body 110 based on the cross-section in the width and thickness directions of the body 110.

The side margin portions 114 and 115 may be a ceramic green sheet region other than the internal electrodes 121 and 122 when the paste for the internal electrode is applied on the ceramic green sheet applied to the capacitance formation portion Ac, other than the side margin portions 114 and 115.

However, an example embodiment thereof is not limited thereto, and the side margin portions 114 and 115 may be formed by forming the internal electrodes 121 and 122 by applying a conductive paste on a ceramic green sheet applied to the capacitance formation portion Ac, other than the regions in which the side margin portions 114 and 115 are formed, cutting the body 110 such that the internal electrodes 121 and 122 after lamination are exposed to the fifth and sixth surfaces 5 and 6 of the body 110 to suppress a step difference caused by the internal electrodes 121 and 122, and disposing or laminating a single fourth dielectric layer or two or more fourth dielectric layers on both end-surfaces in the width direction of the capacitance formation portion Ac.

The side margin portions 114 and 115 may prevent damage to the internal electrodes 121 and 122 due to physical or chemical stress.

The first side margin portion 114 and the second side margin portion 115 may not include the internal electrodes 121 and 122, may include the same material as that of the first dielectric layer 111, may correspond to, for example, a portion of the first dielectric layer 111. Alternatively, when the first side margin portion 114 and the second side margin portion 115 are formed by disposing or laminating the fourth dielectric layer, and the fourth dielectric layer included in the first side margin portion 114 and the second side margin portion 115 may include, for example, a barium titanate (BaTiO₃)-based dielectric material.

A width wm of the side margin portions 114 and 115 may not be specifically limited, and in the description below, the description of the width wm of the side margin portions 114 and 115 may be applied to the width wm of each of the first side margin portion 114 and the second side margin portion 115.

To easily obtain miniaturization and high capacitance of the multilayer electronic component 100, the width wm of the side margin portions 114 and 115 may be 50 μm or less, preferably 30 μm or less, and more preferably 20 μm or less in an ultra-small product.

Here, the width wm of the side margin portions 114 and 115 may be the average width wm of the side margin portions 114 and 115.

Also, the average width wm of the side margin portions 114 and 115 may indicate the average width wm of each of the first and second side margin portions 114 and 115, or may indicate the average width wm of the first and second side margin portions 114 and 115.

The average width wm of the side margin portions 114 and 115 may be measured by scanning a cross-section of the width and thickness direction of the body 110 using a scanning electron microscope (SEM) at 10,000× magnification. More specifically, the average width wm may be the average value calculated by measuring the widths at five points at an equal distance in the thickness direction in the scanned image of one of the side margin portions 114 and 115.

The description below may be applied only when the first side margin portion 114 and the second side margin portion 115 are formed by disposing or laminating the portions on both end-surfaces in the width direction of the capacitance formation portion Ac.

The side margin portions 114 and 115 may include a second dielectric layer, and more specifically, at least one of the first and second side margin portions 114 and 115 may include a second dielectric layer.

In other words, at least a portion of the side margin portions 114 and 115 may include a (α_{β}Γ_{δ}) TiₓO_{y} (β≥0, δ≥0, x>0, y>0) material different from the barium titanate (BaTiO₃)-based dielectric material as a main component.

Hereinafter, when the side margin portions 114 and 115 include a second dielectric layer, for ease of description, the reference numerals may be the same as the second dielectric layers 114b and 115b, which may be the same as the second dielectric layer 111b of the capacitance formation portion Ac, which may be easily understood by those skilled in the art.

More specifically, the side margin portions 114 and 115 may include at least one of the second dielectric layers 114b and 114b and the fourth dielectric layers 114a and 115a. In other words, the side margin portions 114 and 115 may be formed as the fourth dielectric layers 114a and 115a or may be formed as the second dielectric layers 114b and 115b, or a portion of the side margin portions 114 and 115 may include the second dielectric layers 114b and 115b and the other portion may include the fourth dielectric layers 114a and 115a.

In this case, the second dielectric layers 114b and 115b included in the side margin portions 114 and 115 may be disposed to be in contact with the capacitance formation portion Ac, preferably.

The second dielectric layers 114b and 115b of the side margin portions 114 and 115 may not contribute to forming capacitance, but may be disposed to be in contact with the capacitance formation portion Ac, such that burnt-out or insulation breakdown due to unintended electric field concentration under a high-voltage environment may be prevented, and the effect may be more excellent when the layers are disposed to be in contact with the capacitance formation portion Ac.

When the side margin portions 114 and 115 include both the second dielectric layers 114b and 115b and the fourth dielectric layers 114a and 115a, the second dielectric layers 114b and 115b may be disposed to be in contact with the capacitance formation portion Ac, and the fourth dielectric layers 114a and 115a may be disposed to be in contact with the second dielectric layers 114b and 115b. That is, the second dielectric layers 114b and 115b of the side margin portions 114 and 115 may be disposed in the inner direction of the capacitance formation portion Ac based on the width direction, and the fourth dielectric layers 114a and 115a may be disposed in the outer direction of the capacitance formation portion Ac based on the width direction.

In an embodiment of the present disclosure, a multilayer electronic component 100 may have first and second external electrodes 131 and 132, but the number or shape of the external electrodes 131 and 132 may be varied depending on the shape of the internal electrodes 121 and 122 or other purposes.

The first and second external electrodes 131 and 132 may be disposed on the body 110 and may be connected to the internal electrodes 121 and 122, respectively.

More specifically, the first and second external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and may be connected to the second internal electrode 122.

Also, the first and second external electrodes 131 and 132 may extend to and be disposed on portions of the first and second surfaces 1 and 2 of the body 110, or may extend to and be disposed on a portion of the fifth and sixth surfaces 5 and 6 of the body 110. That is, the first external electrode 131 may be disposed on the third surface 3 of the body 110 and a portion of the first, second, fifth, and sixth surfaces 1, 2, 5, and 6 of the body 110, and the second external electrode 132 may be disposed on the fourth surface 4 of the body 110 and a portion on the first, second, fifth, sixth surfaces 1, 2, 5, and 6 of the body 110.

The external electrodes 131 and 132 may include a connection portion disposed on the third and fourth surfaces 3 and 4 of the body 110, and a band portion extending from the connection portion to a portion on the first and second surfaces 1 and 2 of the body 110.

More specifically, the first external electrode 131 may include a first connection portion disposed on the third surface 3 of the body 110, and a first band portion extending from the first connection portion to a portion of the first and second surfaces 1 and 2, and the second external electrode 132 may include a second connection portion disposed on the fourth surface 4 of the body 110, and a second band portion extending from the second connection portion to a portion of the first and second surfaces 1 and 2.

The first band portion may include a 1-1 band portion extending from the first connection portion to a portion of the first surface 1, and a 1-2 band portion extending from the first connection portion to a portion of the second surface 2, and the second band portion may include a 2-1 band portion extending from the second connection portion to a portion of the first surface 1, and a 2-2 band portion extending from the second connection portion to a portion of the second surface 2

In the embodiments, unless otherwise indicated, the description of the band portion may be the description of each of the first band portion and the second band portion, and may be the description of each of the 1-1 band portion, the 1-2 band portion, the 2-1 band portion and the 2-2 band portion.

The external electrodes 131 and 132 may be formed using any material having electrical conductivity, such as metal, and the specific material may be determined in consideration of electrical properties, structural stability, or the like, and the external electrodes 131 and 132 may have a multilayer structure.

For example, the external electrodes 131 and 132 may include first electrode layers 131a and 132a disposed on the body 110, second electrode layers 131b and 132b disposed on the first electrode layers 131a and 132a, and third electrode layers 131c and 132c disposed on the second electrode layers 131b and 132b, respectively.

Here, the first electrode layers 131a and 132a, the second electrode layers 131b and 132b and the third electrode layers 131c and 132c may be distinct from each other, preferably. However, an example embodiment thereof is not limited thereto, and the layers may be distinguished according to the order of the manufacturing process, and at least two electrode layers among the first electrode layers 131a and 132a, the second electrode layers 131b and 132b and the third electrode layers 131c and 132c may not be distinguished from each other and may be observed as an integrated layer.

In the embodiments, being “distinct” may indicate that two layers are distinguished due to a physical difference, chemical difference and/or simple optical difference, and although not limited thereto, the distinction between the layers may be made by the presence or absence of an “interfacial surface.” The interfacial surface may indicate a surface on which two layers in contact with each other are distinguishable from each other, and for example, the layers may be distinguished by a difference in components through EDS analysis using a device such as a scanning electron microscope (SEM).

The first electrode layers 131a and 132a may be formed by transferring a sheet including a conductive metal onto the body 110, or may be formed by applying a conductive paste for external electrode including a conductive metal to the body 110 and firing the paste, or may be formed by dipping the body 110 into a conductive paste for external electrode including a conductive metal, but an embodiment thereof is not limited thereto.

For a specific example of the first electrode layers 131a and 132a, the first electrode layers 131a and 132a may be fired electrodes including a conductive metal and glass.

As the conductive metal included in the first electrode layers 131a and 132a, a material having excellent electrical conductivity may be used, and for example, the conductive metal may include one or more selected from the group consisting of nickel (Ni), copper (Cu), palladium (Pd), silver (Ag), gold (Au), platinum (Pt), tin (Sn), tungsten (W), titanium (Ti), and alloys thereof, but an example embodiment thereof is not limited thereto.

The glass included in the first electrode layers 131a and 132a may improve bonding with the body 110.

The second electrode layers 131b and 132b and the third electrode layers 131c and 132c may improve mounting properties, and may be plating layers formed by plating on the first electrode layers 131a and 132a, but an example embodiment thereof is not limited thereto.

The types of the second electrode layers 131b and 132b and the third electrode layers 131c and 132c are not limited to any particular example, and may include, for example, at least one selected from the group consisting of nickel (Ni), tin (Sn), silver (Ag), palladium (Pd), and alloys thereof.

More specifically, for example, the second electrode layers 131b and 132b may be nickel (Ni) electrode layers, the third electrode layers 131c and 132c may be tin (Sn) electrode layers, or the second electrode layers 131b and 132b may be tin (Sn) electrode layers, and the third electrode layers 131c and 132c may be nickel (Ni) electrode layers.

The size of the multilayer electronic component 100 may not be limited to any particular example.

However, to obtain both miniaturization and high capacitance, the number of laminated layers may need to be increased by reducing the thicknesses of the dielectric layer and the internal electrodes. Thus, the effect in the embodiments may be significant in a multilayer electronic component 100 having a size of 1005 (length×width: 1.0 mm×0.5 mm, length and width satisfy an error of ±10%) or less. Also, the width of the multilayer electronic component 100 may be greater than the length.

Hereinafter, the present disclosure will be described in greater detail through experimental examples, and this is to help a specific understanding of the present disclosure, and the scope of the present disclosure is not limited to the experimental examples.

### Experimental Example

[Table 1] below lists insulation resistance (IR), Step-IR, breakdown voltage (BDV), and dielectric capacitance properties of 20 chips manufactured in a size of 1005 under the same conditions as those of comparative examples 1 and 2 and embodiments 1 to 4.

Comparative examples 1 and 2 did not include a second dielectric layer, the first dielectric layer including barium titanate (BaTiO₃) was repeatedly laminated with the internal electrode, and the number of laminated layers was 500 layers. In this case, the average thickness of the first dielectric layer was 1.0 μm.

Embodiment 1 includes a first dielectric layer including barium titanate (BaTiO₃), a second dielectric layer including Ba(Nb_{0.02}Al_{0.02}) Ti_{0.96}O₃, and an internal electrode. In this case, the second dielectric layer included only one layer in a central portion in the thickness direction of the capacitance formation portion, and each of the average thickness of the first dielectric layer and the average thickness of the second dielectric layer was 1.0 μm. Other than these conditions, the embodiment was manufactured in the same manner as comparative example 1.

Embodiment 2 includes a first dielectric layer including barium titanate (BaTiO₃), a second dielectric layer including Ba(Nb_{0.02}Al_{0.02}) Ti_{0.96}O₃, and an internal electrode. In this case, the first dielectric layer-first internal electrode-second dielectric layer-second internal electrode were laminated in order, and the second dielectric layer included 10 layers in the central portion in the thickness direction of the capacitance formation portion, and each of the average thickness of the first dielectric layer and the average thickness of the second dielectric layer was 1.0 μm. Other than these conditions, the embodiment was manufactured in the same manner as comparative example 1.

Embodiment 3 includes a first dielectric layer including barium titanate (BaTiO₃), a second dielectric layer including Ba(Nb_{0.02}Al_{0.02}) Ti_{0.96}O₃, and an internal electrode. In this case, the second dielectric layer included only one layer in the central portion in the thickness direction of the capacitance formation portion, and the average thickness of the first dielectric layer was 1.0 μm, and the average thickness of the second dielectric layer was 1.5 μm. Other than these conditions, the embodiment was manufactured in the same manner as comparative example 1.

Embodiment 4 includes a first dielectric layer including barium titanate (BaTiO₃), a second dielectric layer including Ba(Nb_{0.02}Al_{0.02}) Ti_{0.96}O₃, and an internal electrode. In this case, the first dielectric layer-first internal electrode-second dielectric layer-second internal electrode were laminated in order, and the second dielectric layer included 10 layers in the central portion in the thickness direction of the capacitance formation portion. The average thickness of the first dielectric layer was 1.0 μm, and the average thickness of the second dielectric layer was 1.5 μm. Other than these conditions, the embodiment was manufactured in the same manner as comparative example 1.

As for insulation resistance (IR) properties, resistance values when a voltage of 6.3 V was applied were measured for 20 sample chips of each experimental example, and the average value thereof was obtained.

As for step-IR properties, the voltage was increased by 0.13 V (corresponding to 0.02 Vr) every 3 hours at a temperature of 120° C. When burnt-out occurred, the sample was evaluated as “fail” and the stage at which burnt-out occurred was indicated. When burnt-out did not occur, the sample was evaluated as “pass,” and experimental examples for which Step-IR properties were not evaluated were denoted as a dash (-).

As for breakdown voltage (BDV) properties, the voltage at which shorts occurred was measured when voltage was applied to 20 sample chips, and the average value thereof was obtained.

As for dielectric capacitance properties, the capacitance values when 1 KHz&1V conditions were applied to 20 sample chips was measured, and the average value thereof was obtained.

TABLE 1

| | | | | Dielectric |
|---|---|---|---|---|
| Experimental | IR @ 6.3 V | Step-IR @ | BDV | capacitance @ |
| example | (Ω) | 120° C. | (V) | 1 kHz&1 V (μF) |
| Comparative | 3.44E+09 Ω | Fail (step 4) | 79 V | 8.76 μF |
| example 1 | | (Burnt) | | |
| Comparative | 3.93E+09 Ω | Fail (step 5) | 92 V | 8.43 μF |
| example 2 | | (Burnt) | | |
| Embodiment 1 | 8.76E+08 Ω | — | 95 V | 8.91 μF |
| Embodiment 2 | 1.26E+09 Ω | Pass | 107 V | 9.13 μF |
| Embodiment 3 | 1.02E+09 Ω | — | 98 V | 8.66 μF |
| Embodiment 4 | 2.46E+09 Ω | Pass | 111 V | 8.96 μF |

It was confirmed that insulation resistance (IR) properties of embodiments 1 to 4 were lower than those of comparative examples 1 and 2. This may be due to the application of a second dielectric layer having low resistivity properties.

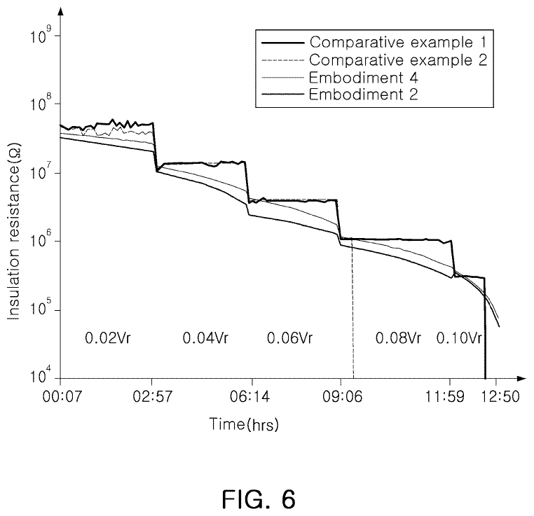

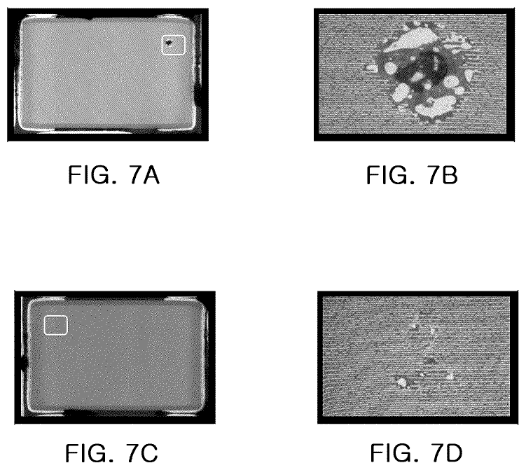

FIG. 6 is a graph of step IR evaluation of comparative examples 1 and 2 and embodiments 2 and 4. FIGS. 7A and 7B are images of burnt-out occurred in comparative example 1, taken by an optical microscope (OM) and a scanning electron microscope (SEM), respectively, and FIGS. 7C and 7D are images of burnt-out occurred in comparative example 2, taken by an optical microscope (OM) and a scanning electron microscope (SEM), respectively.

In comparative examples 1 and 2, burnout occurred at step 4 and step 5, whereas in embodiments 2 and 4, no burnout occurred even when the voltage was increased up to step 5. Thus, embodiments 2 and 4 to which the second dielectric layer was applied had excellent reliability even in a high-voltage environment.

Also, embodiments 1 to 4 to which the second dielectric layer was applied exhibited improved results in the breakdown voltage (BDV) properties as compared to comparative examples 1 and 2 to which the second dielectric layer was not applied, and dielectric properties were also improved in embodiments 1 to 4.

According to the aforementioned embodiments, by preventing burnt-out, cracks, or shorts under a high-voltage environment, withstand voltage properties and reliability of the multilayer electronic component may improve.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The suggested embodiments may be implemented do not exclude the possibilities of combination with features of other embodiments. For example, even though the features described in an embodiment are not described in the other embodiment, the description may be understood as relevant to the other embodiment unless otherwise indicated.

Terms used in the present specification are for describing the embodiments rather than limiting the embodiments. Unless explicitly described to the contrary, a singular form may include a plural form in the present specification

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a first dielectric layer, a second dielectric layer and internal electrodes; and
external electrodes disposed on the body,
wherein the first dielectric layer includes a BaTiO₃ material as a main component, and
wherein the second dielectric layer includes (α_{β}Γ_{δ}) TiₓO_{y} (material, wherein β≥0, δ≥0, x>0, y>0, different from the main component of the first dielectric layer, as a main component, a is one or more selected from the group consisting of Ba, Er, Ca and Sr, and Γ is one or more selected from the group consisting of Nb, Mg, Ta, In, Mn, Hf, Zr and Al.

2. The multilayer electronic component of claim 1, wherein the BaTiO₃ material includes at least one selected from the group consisting of BaTiO₃, (Ba₁₋ₓCaₓ) TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) and Ba(Ti_{1-y}Zr_{y})O₃ (0<y<1).

3. The multilayer electronic component of claim 1, wherein a total content of a dopant doped in the (α_{β}Γ_{δ}) TiₓO_{y} material is 10 mol % or less based on a total element site doped with the dopant.

4. The multilayer electronic component of claim 1, wherein the (α_{β}Γ_{δ})TiₓO_{y} material includes at least one selected from the group consisting of Ba(Nb, Ti)O₃, Ba(Nb, Al, Ti)O₃, Ba(Nb, Ti, Al, Mn)O₃, Ba(Nb, Hf, Ti)O₃, (Ba, Sr) (Nb, Ti)O₃ and (Sr, Er)TiO₃.

5. The multilayer electronic component of claim 1, wherein the (α_{β}Γ_{δ}) TiₓO_{y} material includes at least one selected from the group consisting of Ba(Nb_{0.02}Mg_{0.02}) Ti_{0.96}O₃, Ba(Nb_{0.02}Al_{0.02}) Ti_{0.96}O₃, (Er)_{0.012}Sr_{0.998}TiO₃, (Ta_{0.01}In_{0.01}) Ti_{0.98}O₂, and Sr(Nb_{0.05}Al_{0.05}) Ti_{0.90}O₃.

6. The multilayer electronic component of claim 1, wherein a number of the first dielectric layer is greater than a number of the second dielectric layer in the body.

7. The multilayer electronic component of claim 1, wherein, when an average thickness of the first dielectric layer is defined as tda and an average thickness of the second dielectric layer is defined as tdb, 1≤tdb/tda≤2 is satisfied.

8. The multilayer electronic component of claim 1, wherein an average thickness tda of the first dielectric layer satisfies tda≤1.0 μm, and an average thickness tdb of the second dielectric layer satisfies tdb≤1.5 μm.

9. The multilayer electronic component of claim 1,
wherein body includes a capacitance formation portion including the first dielectric layer, the second dielectric layer, and the internal electrodes alternately disposed with at least one of the first dielectric layer and the second dielectric layer in the thickness direction, and a cover portion disposed in the thickness direction of the capacitance formation portion, and
wherein the cover portion includes the second dielectric layer.

10. The multilayer electronic component of claim 9, wherein the second dielectric layer included in the cover portion is disposed to be in contact with the capacitance formation portion.

11. The multilayer electronic component of claim 10,
wherein the cover portion further includes a third dielectric layer including BaTiO₃ as a main component, and
wherein the third dielectric layer is disposed in contact with the second dielectric layer.

12. The multilayer electronic component of claim 1,
wherein the body includes a capacitance formation portion including the first dielectric layer, the second dielectric layer, and the internal electrodes alternately disposed with at least one of the first dielectric layer and the second dielectric layer in a thickness direction,
wherein the multilayer electronic component further includes a side margin portion disposed in a width direction of the capacitance formation portion, and
wherein the side margin portion includes the second dielectric layer.

13. The multilayer electronic component of claim 12, wherein the second dielectric layer included in the side margin portion is disposed to be in contact with the capacitance formation portion.

14. The multilayer electronic component of claim 13,
wherein the side margin portion further includes a fourth dielectric layer including BaTiO₃ as a main component, and
wherein the fourth dielectric layer is disposed to be in contact with the second dielectric layer.

15. A multilayer electronic component, comprising:
a body including a first dielectric layer, a second dielectric layer and internal electrodes,
wherein an average thickness of the second dielectric layer is thicker than an average thickness of the second dielectric layer,
wherein the first dielectric layer includes a BaTiO₃ material as a main component, and
wherein the second dielectric layer includes a dielectric material comprises one or more selected from the group consisting of Nb, Mg, Ta, In, Mn, Hf, Zr and Al.

16. The multilayer electronic component of claim 15, wherein the dielectric material included in the second dielectric layer comprises at least one selected from the group consisting of Ba(Nb, Ti)O₃, Ba(Nb, Al, Ti)O₃, Ba(Nb, Ti, Al, Mn)O₃, Ba(Nb, Hf, Ti)O₃, (Ba, Sr) (Nb, Ti)O₃ and (Sr, Er) TiO₃.

17. The multilayer electronic component of claim 15, wherein the body includes the second dielectric layer in a middle section in a thickness direction of the multilayer electronic component.

18. The multilayer electronic component of claim 15, wherein the body includes a higher number of the second dielectric layer than the first dielectric layer.

19. A multilayer electronic component, comprising:
a body including: a first dielectric layer; a second dielectric layer; internal electrodes; a capacitance formation portion including the first dielectric layer, the second dielectric layer, and the internal electrodes alternately disposed with at least one of the first dielectric layer and the second dielectric layer in the thickness direction; and a cover portion disposed in the thickness direction of the capacitance formation portion,
wherein the first dielectric layer includes a BaTiO₃ material as a main component, and
wherein the second dielectric layer includes a dielectric material comprises one or more selected from the group consisting of Nb, Mg, Ta, In, Mn, Hf, Zr and Al,
wherein the cover portion includes the second dielectric layer.

20. The multilayer electronic component of claim 19, wherein the cover portion further includes a third dielectric layer including BaTiO₃ as a main component, and
wherein the third dielectric layer is disposed in contact with the second dielectric layer.
